(19) United States
(12) Patent Application Publication
(10) Pub. No.: US 2025/0240234 A1
(43) Pub. Date: Jul. 24, 2025

(54) SEMANTIC ROUTING FOR TIME VARYING NETWORKS

(71) Applicant: Airbus SAS, BLAGNAC (FR)

(72) Inventor: Paulo-Jorge MILHEIRO MENDES, BLAGNAC (FR)

(21) Appl. No.: 19/028,664

(22) Filed: Jan. 17, 2025

(30) Foreign Application Priority Data
Jan. 19, 2024 (EP) 24152901.5

(51) Int. Cl. H04L 45/12; H04B 7/185; H04L 45/745

(52) U.S. Cl. CPC H04L 45/126; H04B 7/18521; H04L 45/745

(57) ABSTRACT

A semantic routing method for time varying networks, wherein the method is configured to provide a congestion-aware source-based routing for satellites, preferably LEO constellations, with a distributed name resolution system, comprising a multitude of routers, a multitude of border routers, and a service provider. Wherein the method comprises an announcement phase and a forwarding phase executed in a proactive mode or a reactive mode.

### CROSS-REFERENCES TO RELATED APPLICATIONS

This application claims the benefit of European Patent Application Number 24152901.5 filed on Jan. 19, 2024, the entire disclosure of which is incorporated herein by way of reference.

### FIELD OF THE INVENTION

The present invention relates to a semantic routing method for time varying networks, which is a congestion-aware source-based routing solution for satellites with a distributed name resolution system.

### BACKGROUND OF THE INVENTION

Routing protocols currently used in the internet expect to maintain contemporaneous, end-to-end connected paths across a network. Changes to that connectivity, such as the loss of an adjacent peer, need the routing protocols to react to reduce the impact on the network traffic.

However, a growing number of use cases exist where predicted variations (restoration, activation, or loss) to the topology are an expected part of normal network operations. For example, in networks with mobile nodes, such as aerial vehicles (e.g. UAM, UAS, commercial aircraft) and spacecraft systems such as LEO constellations, links can be lost and re-established, or neighbors may change as a function of their mobility or availability of resources. In such time-varying networks, traffic might be routed based on other metrics than hop count, such as energy costs or expected availability of services, which may vary predictably over time. In these cases, the predicted loss and restoration of an adjacency, or formation of an alternate adjacency, should be seen as non-disruptive events.

One clear example of a time-varying network is a LEO (Low Earth Orbit Satellite) constellation. Satellite LEO constellations have been studied for decades under the assumption that satellites can directly communicate with each other in space using laser-based Inter-Satellite Links (ISLs), forming a space-based optical mesh network. A typical path for Internet access consists of an uplink, with Radio Frequency (RF) signals, from a user terminal to a satellite, a satellite-to-satellite optical path, and a RF downlink to a gateway connecting to the Internet. Due to the fast movement of satellites, frequent handoffs between user terminal/gateway and satellite are expected.

For the operation of a LEO constellation several networking aspects have to be considered, namely handling limits for packet drops, and latency, essentially determining the requirements or finding suitable network paths in a network with dynamic connectivity and restricted resources. In this scenario, a good routing solution is needed to provide a good distribution of traffic, while being aware about the flexibility of the network, in order to cope with link or node failures.

Besides the networking and traffic aspects, other system considerations, such as resource management may affect the performance of any solution aiming to route traffic over a time-varying network. such as: i) on-board radios may be turned off to allow other node processing; ii) optical terminals may be turned off when devices are too close, such as satellites near the poles; iii) network functions may be switched off if there are thermal considerations on the node. such as an increase in a node's operating temperature.

In the literature, various current routing algorithms for time-varying networks have been proposed, aiming to improve the network throughput and reduce end-to-end delays while supporting reliable connectivity. For instance, in the case of LEO constellations the aim is to use a routing framework that allows large amounts of data to be forwarded over long distances, through ISLs. However, the terrestrial core network is reasonably robust and resource-abundant now, and multi-hop transmission, through unstable ISLs, would bring additional repeat request overhead. Therefore, how to route traffic over LEO mega-constellation to provide ultra-reliable and low-latency communication services remains an open issue, as so it is the topic of this IDD.

Moreover, in order to suppose not only the dynamics of the network topology but also the needed adaptation to services, time-varying networks should be able to adjust the network architecture and configurations based on service requirements and availability. In the future it is envisioned that novel routing approaches to time-varying networks should be able to route traffic based on the service that is being communicated (and invoked) instead of focusing on the devices that are requesting and providing such service.

In this section we focus the analysis of prior art on a specific use-case of time-varying networks, satellite LEO constellations. However, the same solution can be applied to other scheduled time-varying networks, such as flying networks, in which devices move based on predefined routes (e.g. commercial aircraft).

Routing in satellites generally maps to two categories: snapshot routing, and dynamic routing. In the former case, the topology of the satellite constellation is supposed to be static or the duration of a snapshot and the routing is then performed on this static topology. Due to the different latency for a packet transmission (of the order of milliseconds) and the motion of the satellite (that can be in view of a ground station for several minutes), this assumption is reasonable. As the topology evolves, a new routing table is populated for the next snapshot. Routing tables can typically be precomputed in a central server and uploaded to minimize the processing workload in the satellite.

Snapshot bases solutions were already common in Hong Seong Chang, Byoung Wan Kirn, Chang Gun Lee, Yanghee Choi, Sang Lyul Mm, Hyun Suk Yang, and Chong Sang Kirn. 1995. Topological design and routing for low-Earth orbit satellite networks, in proceedings of GLOBECOM ‘95, by observing that the topology of the satellite constellation followed a limited number of possible states. Therefore, a Finite State Automaton (FSA) could be constructed ahead of time. For each state, a configuration could be pre-calculated and loaded into the satellite, meaning that satellite themselves did not have to perform computation, but only to load the topological configuration and routing that corresponds to a specific state similar snapshot approach, V. V. Gounder, R. Prakash, and H. Abu-Amara. 1999. Routing in LEObased satellite networks. In 1999 IEEE Emerging Technologies Symposium. Wireless Communications and Systems (IEEE Cat. No.99EX297). IEEE, 22.1-22.6., defines similar states, denoted as snapshots, which correspond to the topology of the satellite network at a particular instant of time. Each satellite stores the routing information corresponding to a few snapshots that are uploaded periodically from the ground stations. A similar approach, but that relies on the computation of snapshots on a centralized server, is followed by Contact Graph Routing, Juan Andres A Fraire, Olivier de Jonckere, Scott C Burleigh. Routing in the Space Internet: A contact graph routing tutorial. Journal of Network and Computer Applications (JNCA), 2021, which is focused on scheduled Delay-Tolerant Networks (DTN) which can take advantage of a contact plan comprising the future network connectivity in order to make efficient forwarding decisions. With CGR, the centrally computed contact plan is uploaded to all satellites, allowing each satellite to compute the shortest router to any other satellite in the system, by using the contact plan with Dijkstra algorithm.

Other routing solutions that rely on computing shortest paths are based on the Open Shortest Path First (OSPF) protocol (IETF rf02328) which has been extended to fit the specific properties of LEO constellations. An example is the Area-based Satellite Routing protocol (ASER), Xiang Zhang, Yuan Yang, Mingwei Xu, and Jing Luo. 2021. ASER: Scalable Distributed Routing Protocol for LEO Satellite Networks. In IEEE 46th Conference on Local Computer Networks (LCN), which is a hierarchical grouping of satellites within an area. ASER ground assumption is that the topology within an area is static, in which case ASER is used to connect these areas dynamically. Another example is the Orbit Prediction Short Path First (OPSPF), Tian Pan, Tao Huang, Xingchen Li, Yujie Chen, Wenhao Xue, and Yunjie Liu. 2019. OPSPF: Orbit Prediction Shortest Path First Routing for Resilient LED Satellite Networks, in IEEE International Conference on Communications (ICC), which extends OSPF taking into account the periodic predictability of the apology. This fixes the issue of endless route convergence with OSPF that consumes expensive intersatellite link bandwidth.

All these solutions that aim to compute shortest paths based on contact plan information, such as CGR and other solutions based on OSPF and Dijkstra seem to work well as long as networks remain small or medium size, G. Wang, S. C. Burleigh, R. Wang, L. Shi, and Y. Qian, “Scoping contact graph-routing scalability: Investigating the system's usability in space-vehicle communication networks,” IEEE Vehicular Technology Magazine, vol. 11, no. 4, pp. 46-52, December 2016. In all these approaches, the routing computation effort and its impact on the scalability of the network has been considered a secondary goal so far.

To solve the scalability issue, a common strategy is to divide the large satellite LEO constellation into several regions, being Dijkstra or a similar algorithm used inside each region to identify shortest paths between any pair of satellites, Hou Dongxu, Xiao Min, Fenlin Zhou, “Routing Framework for LED Mega-constellation Based on Region Division”, IETF draft (draft-hou-rtgwg-satellite-routing-framework-00), July 2023. Some proposals focus also on using Dijkstra or similar algorithm to coordinate the routing between different regions based on an abstract model in which each networked node represents one region, Pablo G. Madoery, Juan A. Fraire, Fernando D. Raverta, Jorge M. Finochietto, Scott C. Burleigh, “Managing Routing Scalability in Space DTNs”, in Proc. of IEEE International Conference on Wireless for Space and Extreme Environments (WiSEE), 2018.

The alternative to snapshot based solution is to devise dynamic routing protocols, based on which satellites forward packets based upon the current network configuration. This means that the routing protocol must dynamically adapt to changes in the topology, as the length of time a snapshot is stable is rather short, which is a problem similar to characterizing the stability of a path in other type of time-varying networks—ad hoc networks, Claude Richard, Charles E Perkins, and Cedric Westphal. 2005. Defining an optimal active route timeout for the AODV routing protocol. In Proc. Second Annual IEEE Communications Society Conference on Sensor and Ad-Hoc Communications and Networks, (IEEE SECON). 26-29.

One example may pass by adapting well known dynamic routing protocols such as AODV (IETF rfc3561) to satellite networks. In this context the Location-Assisted On-demand outing (LAOR) protocol, E. Papapetrou, 5. Karapantazis, and F.-N. Pavlidou. 2007. Distributed on-demand routing for LED satellite systems. Computer Networks 51, 15 (2007), 4356-4376. invokes the shortest path discovery procedure independently or each individual communication request, which adds a significant overhead. For a highly dynamic topology, a protocol that allows for some path flexibility around the short path (such as OPRAH, Cedric Westphal. 2006. Opportunistic Routing in Dynamic Ad Hoc Networks: the OPRAH protocol. In 2006 IEEE International Conference on Mobile Ad Hoc and Sensor Systems.) may provide benefits over AODV.

In order to bring some flexibility to snapshot and dynamic routing protocols, allowing them to react to link failures, some protocols use repairing strategies, such as the destruction-resistant On-Demand Routing protocol DODR, Xuezhi Ji, Lixiang Liu, Pei Zhao, and Dapeng Wang. 2015. A destruction-resistant n-demand routing protocol for LED satellite network based on local repair. In 2015 12th International Conference on Fuzzy Systems and Knowledge Discovery (FSKD). 2013-2018, which is an ad hoc protocol that leverages route replies (RREPs in AODV) in the path discovery process, as well as a local repair strategy, to identify and fix broken paths quickly without incurring heavy overhead. Another example is the Disruption Tolerant Distributed Routing (DTDR) protocol, Jifeng Jin, Feng Tian, Zijian Yang, Hao Di, and Guotong Li. 2022. A Disruption Tolerant Distributed Routing Algorithm in LEO Satellite Networks. Applied Sciences 12, 8 (2022), which is able to react to failures by only broadcasting the failed link information (as opposed to link status updates) to reduce the overhead, by taking advantage of the relatively static (or periodic) mesh topology of the satellite constellation.

While all these protocols aim to provide failure recovery by ensuring a fast convergence time, another approach may be to avoid any dependency upon topology information, relying on geographic information instead. Examples are proposals for routing mechanisms that selects the next hop based upon minimizing the remaining Euclidean distance towards the destination, T. R. Henderson and R. H. Katz. 2000. On distributed, geographic based packet routing for LED satellite networks. In Globecom ‘00—IEEE. Global Telecommunications Conference, Conference Record (Cat. No.00CH37137), Vol. 2. In regular conditions. geographic routing is close to the optimal path (bounding the delay difference by 10 ms). However, such protocols may break down at the counter-rotating seams, the polar regions, and close to the destination of a packet.

Geographic routing has been considered to handle many other time-varying topologies, such as in ad-hoc networks, Julien Herzen, Cedric Westphal, and Patrick Thiran. 2011. Scalable Routing Easy as PIE: a Practical Isometric Embedding Protocol. In IEEE ICNP. The benefit of geographic routing is that the routing is extremely simple, once the relative position of the current node, its neighbors and the destination is known: picking the neighbor's closest to the destination is a simple computation. This seems a good fit for satellite networks, in which satellites have resource constraints, but are aware of their geographic position. However, in a satellite network, the destination (on the ground) is not static with respect to the moving constellation. The topology also varies between the ascending and descending satellites, meaning that the possibility to use other types of addressing information besides the geoposition of devices may bring benefits.

This requirement of using different address semantics, is also aligned with the expectation that in the future different satellite systems will need to inter-operate. Therefore, defining protocols for an Internet of satellites based on instructive routing and semantic addressing may be appropriate, Lin Han, Richard Li, Alvaro Retana, Chen Meiling, Li Su, and Ning Wang. “Problems and Requirements of Satellite Constellation for Internet”. Internet draft (draft-Ihan-problems-requirements-satellitenet-05), July 2023. By using the semantic address of LEO satellites, Lin Han, Alvaro Retana, and Richard Li. “Semantic Address Based Instructive Routing for Satellite Network”. Internet draft draft-lhan-satellite-instructive-routing-03, September 2023, packet forwarding could be just a simple instruction like “forwarding the packet in a specified direction until reaching a specified satellite”. Compared with the traditional hop-by-hop IP packet forwarding (based on Longest Prefix Match lookup for the routing table), the new solution can be more adaptive to the very dynamic network topology while the packet overhead is less than the IPv6 Segment Routing (SRv6).

### SUMMARY OF THE INVENTION

It is an object to operate based on semantics such as geolocation, IP address, service name, information about congestion.

It is another object to have an embedded distributed system for resolving service names to semantic addresses.

It is another object to use source based routing allowing satellites to implement a simple routing engine.

It is another object to operate based on geographic routing, which is able to adapt to network dynamic, forwarding traffic via a set of satellites as dose as possible from the destination.

It is another object to, if aware of congestion, be able to route traffic around congested satellites.

It is another object to be able to support multicast traffic by allowing semantic addresses to include multiple destinations.

These objects may be achieved by one or more embodiments of the present invention described herein.

According to one aspect, a semantic routing method for time varying networks, wherein the method is configured to provide a congestion-aware source-based routing for satellites, preferably LEO constellations, with a distributed name resolution system is provided. A multitude of routers, a multitude of border routers and a service provider is provided.

The method comprises an announcement phase comprising the following steps:
Create a border router order list of the multitude of border routers by incremental order their distance to a current border router;
Create, by the current border router, a semantic packet with a list of several directives pairs of the following type:
Forward (Forward.pkt.areaID) the semantic packet to specific geographic area with geolocation ID of a geographic area of a destination border router;
Broadcast (Forward.pkt.servID) the semantic packet towards specific service ID with the IP address of the multitude of a border router with a radius R;
End (Forward.pkt.end) the execution of directives;
Execute, by the current border router, the first directive on the list;
Receive, by the multitude of routers, the semantic packet and execute the directives starting from the first one, wherein:
if a router is not in the geographic area of the destination border router, further forward the semantic packet to neighbor routers; or
if a router is in the geographic area of the destination border router, the semantic packet is broadcasted within the geographic area until it reaches a router with a connection to the destination border router or expiring the radius R, wherein the router with a connection to the destination border router or expiring the radius R sends the payload of the semantic packet to the current border router and the router with a connection to the destination border router or expiring the radius R executes the following directive in the semantic packet, wherein all the other routers within the geographic area execute the last directive carried in the semantic packet (Forward.pkt.end).

The method further comprises a forwarding phase, wherein information previously exchanged between the multitude of border routers is used to forward data packets, wherein the forwarding phase is configured to be executed in a proactive mode or a reactive mode, wherein:
in the proactive mode, the multitude of border routers trigger themselves a semantic packet with a path discovering message to specific services in order to identify the most suitable path, wherein the information about the identified path is placed in a local routing table and used as tags in future semantic packets allowing a faster forwarding inside the time-varying network, and
in the reactive mode, the multitude of border routers trigger the transmission of a semantic packet to carry a data packet that was received from an interface connecting to an external network, wherein the multitude of border routers create a semantic packet that is forwarded by routers, which do not store any state in the process, wherein the semantic packet comprises a header with the IP address of the border router as source address and the IP address of a destination service, as well as a payload with the received data packet and an extended header that allows the payload to be distributed in a unicast mode,
such that the method (100) is operated based on geographic routing, which is able to adapt to network dynamic, forwarding traffic via a set of satellites as close as possible from the destination.

In comparison with other approaches that aim to route traffic over a constellation of LEO satellites, this invention has the following benefits:
Operates based on semantics such as geolocation, IP address, service name, information about congestion.
Has an embedded distributed system for resolving service names to semantic addresses.
Uses source based routing allowing satellites to implement a simple routing engine.
Operated based on geographic routing, which is able to adapt to network dynamic, forwarding traffic via a set of satellites as close as possible from the destination.
If aware of congestion, being able to route traffic around congested satellites
Is able to support multicast traffic by allowing semantic addresses to include multiple destinations.

A router is responsible for forwarding semantic packets (with payload related to data packets and border state announcements). In order to support these actions a router needs to perform internal operations to estimate its position and congestion level. The operation of a router is divided into two states: packet forwarding and status computation. The former is triggered by the reception of a semantic packet, while the latter is triggered periodically.

Based on an internal timer and the information carried in the header (and extender header) of semantic packets, the router implements the following operations:
Reception of packets: This function is triggered by the reception of semantic packets from neighbor nodes. The router first checks if the packet has extended headers.

If so it executes the instruction stored in the extended header.
Internal triggers:
   Congestion function:
      Estimate its congestion level, by analyzing the status of networking queue, storage (if existent), power levels, in a configured time interval.
      Broadcast the current congestion level to all neighbor nodes.
   Geoposition function:
      Estimate its geographic position by querying a locally installed GPS device, in a configured time interval
   Broadcasts the estimated geoposition value to neighbor nodes.

A Border Router is responsible for interfacing the time-varying network with other IP networks with which packets can be exchanged. The operation of a border router consists of the following functions:
Local configuration:
   Identifying its precise geoposition as well as the geoposition of the geometric area where it is deployed.
   Storing information about all the other service edges of the time-varying network (provided by the network Operator via configuration interface).

This Information includes: service Edge ID; Service Edge geoposition.
Service registration function:
Receiving registration of service instances from any network provider, being the service instance identified by its name and IP address where the service is running. This IP address may be of the Service Edge in case the service registration required local installation of the service instance.
Storing the service instance information based on a tuple (service name; IP address).
Border state announcement:
   Disseminating to all known service edges Information of registered service instances, namely their service names and the geoposition information of the announcing service edge, as well as the geographic identification of the geometric area where the service edge is deployed.
   Receiving and storing information about service instances registered in other service edges.
Gateway function:
Receiving data packets from devices outside the time-varying network direct to
specific services identified by their name. Encapsulating those packets into a semantic packet to be forwarded towards selected services inside the time-varying network.
Receiving semantic packets from internal routers. In this case the gateway processes the carried payload, forwarding the packet to the destination identified in the packet header.

A service provider can register several different instances of the same service in different service edges, based on its reliability policies.

According to one embodiment executing the forwarding phase in the reactive mode comprises the following step:

Receive, by the multitude of border routers, a semantic packet from an external network.

According to one embodiment, the method further comprises the following step:

Use, by the multitude of border routers, a service name carried in the received data packet to check local stored information in order to identify a border router hosting that service.

According to one embodiment, the method further comprises the following step:

Select, from the list of possible hosting border routers, a specific one that is based on a configured forwarding strategy.

According to one embodiment, the method further comprises the following steps:

Create, by the multitude of border routers, of a semantic packet with the following routing directives in the extended header:
Forward (Forward.pkt.areaID) packet to specific geographic area with geolocation ID of the geographic area of the destination border router;
Broadcast (Forward.pkt.servID) packet towards specific service ID with the radius R used to forward the packet to the service ID (IPv6 address) indicated in the packet header;
End (Forward.pkt.end) the execution of directives.

Execute, by the multitude of border routers, the first directive on the list.

According to one embodiment, the method further comprises the following step:

Receive the semantic packet and execute the directives, by the multitude of border routers, starting from the first one, wherein:
if a router is not in the geographic area of the destination border router, forward the semantic packet to the neighbor router that is geographically closer to the destination and which is the least congested one; or
if a router is in the geographic area of the destination border router, the semantic packet is broadcasted within the geographic area until it reaches the router with a connection to the service ID indicated in the packet header or until expiring the radius R, wherein the router sends the payload of the semantic packet to the border router, wherein all the other routers within the geographic area execute the last directive carried in the semantic packet (Forward.pkt.end).

According to one embodiment, executing the forwarding phase in the proactive mode comprises the following steps:
Select, by the multitude of border routers, one of locally installed services.

According to one embodiment, the method further comprises the following step:

Create, by the multitude of border routers, a semantic packet with the following routing directives in the extended header:
Collect (Discover.path.to.areaID) information about routers in the path towards a specific geographic area with geolocation ID of the geographic area of the destination border router;
Create (Create.reverse.pkt) a new semantic packet;
End (Forward.pkt.end) execution of directives;
Execute, by the multitude of border routers, the first directive on the list.

According to one embodiment, the method further comprises the following step:

Receive, by the multitude of border routers, the semantic packet and execute the directives starting from the first one, wherein:
if the router is not in the geographic area of the destination border router, the router:
   i. Identifies the neighbor router that is geographically closer to the destination and is the least congested one;
   ii. Adds the ID of the selected neighbor node at the head of the router address chain in the packet payload;
   iii. Forwards the semantic packet to the selected neighbor router; or
if the router is in the geographic area of the destination border router, the router adds its ID to the head of the Router address chain, and executes the next directive.

According to one embodiment, the method further comprises the following step:

Create, by the destination router, a new semantic packet with the IP address of the current router as source address, the service ID as carried in the previous packet as destination address, the chain-index in the packet head at 1, and the following directives:
Forward (Forward.pkt.chainID) the semantic packet to specific geographic area with router address chain collected from the received semantic packet;
Store (Stores.chain.servID) information about a received chain of routers;
End (Forward.pkt.end) execution of directives.

According to one embodiment, the method further comprises the following step:

Execute, by the destination router, the first directive.

According to one embodiment, the method further comprises the following step:

Execute, by the multitude of border routers, the first directive on the list, forwarding the semantic packet to the router whose IP address is the first as indicated in the directive and increase the chain-index by 1.

According to one embodiment, the method further comprises the following step:

Execute the second directive, by the multitude of routers receiving a semantic packet with a chain-index bigger than the size of the router address chain, and store the router address chain associated to the service which ID as indicated in the packet header as destination IP.

According to one embodiment, wherein for all services that have a non-empty router address chain, the border router will use the following procedure to forward data packets:
Receive, by the border router, a packet from an external network;
Use, by the border router, the service name carried in the received data packet to check the local stored information in order to identify the router address chain associated with that service;
Create, by the border router, a semantic packet with a header with the IP address of the border router as source address and service ID of the selected service as destination address, as well as with the following routing directives:
Forward (Forward.pkt.chainID) packet via a set of known routers with the Router address chain locally stored for the received service name.
Broadcast (Foward.pkt.servID) the semantic packet towards specific service ID with the radius R used to forward the packet to the service ID (IPv6 address) indicated in the packet header.
End (Forward.pkt.end) the execution of directives;
Execute, by the border router, the first directive on the list;
Receive, by the multitude of routers, the semantic packet and execute the directives starting from the first one, wherein, if the router address chain is not empty, the router removes first address from the router address chain and forwards the resulting packet to the neighbor router with that IP address.

According to one embodiment, wherein, if the router address chain is empty, the router broadcasts the semantic packet until reaching a router with a connection to the service ID or until expiring the radius R, wherein the router sends the payload of the semantic packet toward the border router that is reachable via the interfaces configured with the ServiceID, wherein all routers within the geographic area execute the last directive carried in the semantic packet (Forward.pkt.end).

In other words, a semantic routing method for time varying networks, which is a congestion-aware source-based routing solution for satellites LEO constellations with a distributed name resolution system.

The proposed mechanism allows traffic to be forwarded in a time-varying network, such as a LEO constellation by using semantic addresses which are built based on a combination of the geolocation of the area where the destination is plus an IPv6 address that identifies a specific service instance. In this sense the proposed solution is different from previous semantic routing tor satellite systems, which propose a method for routing based on the satellite semantic address. In the proposed solution there is no need to identify satellites and to track their position in a network topology.

The proposed routing solution allows the deployment of time-varying networks, such as LEO constellation, while being agnostic of locator-based addressing, since the address semantics relate to services being invoked (geoposition and Identifier). In order to reduce the delay needed to use traditional name resolution systems, such as Domain Name Services (DNS), the proposed routing protocol encompasses the needed signaling to allow edge routers to create semantic addresses based on the requested service name.

A time-varying network encompasses a set of moving nodes (operating as routers), each one with a set of point-to-point or omnidirectional wireless interfaces to neighbor nodes (e.g. radio links or free space optical links). Some of the nodes of the time-varying network may have an interface to gateway nodes (operating as border routers), which provide connectivity to non-time varying networks.

It is assumed that the earth's surface is divided in circular geometric areas with equal radius (configured value) and identified by the geolocation of its centrum. It is also assumed that routers and border routers are aware of such division of the earth surface and that:
Border routers can be deployed in fixed positions inside certain geometric areas, or can move inside and between geometric areas. Examples can be satellite ground stations or mobile satellite terminals.
Routers can handover between adjacent geometric areas based on a predefined path (e.g. satellite orbit or aircraft route/mission). Examples can be satellites or aircraft.

During the announcement phase, border routers announce information about local installed services to all known border routers. In this operation. border routers create a semantic packet with the IP address of the border router as source address and the IP address of the final border router to be reached as destination address. The created semantic packet has a payload with a list of data items that identity local services, in which each item encompasses:
Service name
Service ID (IPv6 address)
Geolocation ID of the border router geographic area

The semantic packet is created with an extended header that allows the payload to be distributed in a multicast faction.

The announcement phase comprises the following steps:
1. Border router order list of known border routers by incremental order of their distance to the current border router.
2. Border router creates a semantic packet with a list of several directives pairs of the following type:
   Forward.pkt.areaID with geolocation ID of the geographic area of destination border router
   Forward.pkt.servID with the IP address of the border router with radius R The list is ended with the directive Forward.pkt.end.

The resulting directive list has two times +1 the number of entries of the list created in step 1.
3. Border router executes the first directive on the list.
4. Routers receive the semantic packet and execute the directives starting from the first one. The following action may happen:
   Router is not in the geographic area of the destination border router, in which case it will further forward the semantic packet to neighbor routers.
   Router is in the geographic area of the destination border router, in which case the semantic packet is broadcasted within the geographic area until it reaches the router with a connection to the destination border router or expiring the radius R. In the former case the router sends the payload of the semantic packet to the border router. and the router executes the following directive in the semantic packet. All the other routers within the geographic area execute the last directive carried in the semantic packet (Forward.pkt.end).

During the forwarding phase the information previously exchanged between border routers is used to forward data packets in two modes: reactive and proactive.

Reactive mode: Border routers forward data packets to selected services based on a semantic packet. The forwarded semantic packets do not leave state in routers. This phase is triggered by the reception of data packets from customers outside the time-varying network.

Proactive mode: In this case the border routers trigger themselves a semantic packet with a path discovering message to specific services (e.g. with low delay requirements) in order to identify the most suitable path. The information about the identified path is placed in a local routing table and used as tags in future semantic packets, aiming to allow for a faster forwarding inside the time-varying network.

In the reactive mode, border routers trigger the transmission of a semantic packet to carry a data packet that was received from an interface connecting to an external network. In this operation, border routers create a semantic packet that is forwarded by routers, which do not store any state in the process. The semantic packet has a header with the IP address of the border router as source address and the IP address of the destination service (after the resolution step, as mentioned below), as well as a payload with the received data packet and an extended header that allows the payload to be distributed in a unicast mode.

The forwarding phase operating in a reactive mode comprises the following steps:
5. Border router receives a packet from an external network.
6. Border router uses the service name carried in the received data packet to check the local stored information in order to identify the border routers that host that service.
7. From the list of possible hosting border routers, one is selected based on a configured forwarding strategy.
8. Border router creates a semantic packet with the following routing directives in the extended header:
   Forward.pkt.areaID with geolocation ID of the geographic area of the destination border router.
   Forward.pkt.servID with the radius R used to forward the packet to the service ID (IPv6 address) indicated in the packet header.
   Forward.pkt.end.
9. Border router executes the first directive on the list.
10. Routers receive the semantic packet and execute the directives starting from the first one. The following action may happen:
   Router is not in the geographic area of the destination border router, in which case it will forward the semantic packet to the neighbor router that is geographically closer to the destination and which is the least congested one (based on information collected from the periodic information received from neighbor nodes).
   Router is in the geographic area of the destination border router, in which case the semantic packet is broadcasted within the geographic area until it reaches the router with a connection to the service ID indicated in the packet header (destination address) or until expiring the radius R. In the former case the router sends the payload of the semantic packet to the border router. All routers within the geographic area execute the last directive carried in the semantic packet (Forward.pkt.end).

An example of a forwarded strategy is Load Balancing, in which case the border router selects as the next border router, the one for which it sent less packets in the past. Different forwarding strategies can be used for different types of service.

In the proactive mode, border routers trigger the transmission of a semantic packet to discover the best path to one or more of the services whose information is locally stored.

In this operation, border routers create a semantic packet that is forwarded by routers, which not store any state in the process. The semantic packet has the IP address of the border router as source address, and the service ID (IPv6 address) as destination address, as well as an extended header that allows the payload to be distributed in a unicast mode. and is started with a payload encompasses a Router address chain, which starts with the IP address of source border router.

The forwarding phase operating in a proactive mode has the following steps:
1. Border router selects one of the locally installed services
2. Border router creates a semantic packet with the following routing directives in the extended header:
   Discover.path.to.areaID with geolocation ID of the geographic area of destination border router.
   Create.reverse.pkt.
   Forward.pkt.end.
3. Border router executes the first directive on the list.
4. Routers receive the semantic packet and execute the directives starting from the first one. The following action happens:
   Router is not in the geographic area of the destination border router, in which case it:
      i. Identifies the neighbor router that is geographically closer to the destination and is the least congested one.
      ii. Adds the ID of the selected neighbor node at the head of the Router address chain in the packet payload.
      iii. Forwards the semantic packet to the selected neighbor router.
   Router is in the geographic area of the destination border router, in which case the router adds its ID to the head of the Router address chain, and executes the next directive.
5. The destination router creates a new semantic packet with the IP address of the current router as source address, the service ID (IPv6 address) as carried in the previous packet as destination address, the chain-index in the packet head at 1, and the following directives:
   Forward.pkt.chainID with Router address chain collected from the received semantic packet.
   Stores.chain.servID.
   Fwd.pkt.End.
6. The destination router executes the first directive.
7. Routers execute the first directive on the list, forwarding the semantic packet to the router whose IP address is the first as indicated in the directive and increase the chain-index by 1.
8. Router that receives a semantic packet with a chain-index bigger than the size of Router address chain (which indicates that the router is the source border router) executes the second directive, storing the Router address chain associated to the service which ID as indicated in the packet header as destination IP.

This process is repeated to all services for which the border router would like to have a faster reaction (e.g. lower latency) when data packets arrive.

For all services that have a non-empty Router address chain, the border router will use the following procedure to forward data packets:
1. Border router receives a packet from an external network.
2. Border router uses the service name carried in the received data packet to check the local stored information in order to identify the Router address chain associated with that service.
3. Border router creates a semantic packet with a header with the IP address of the border router as source address and service ID (IP v6 address) of the selected service as destination address, as well as with the following routing directives:
   Forward.pkt.chainID with the Reuter address chain locally stored for the received service name.
   Foward.pkt.servID with the radius R used to forward the packet to the service ID (lPv6 address) indicated in the packet header.
   Forward.pkt.end.
4. Border router executes the first directive on the list.
5. Routers receive the semantic packet and execute the directives starting from the first one. The following action may happen:
   If the Router address chain is not empty, router removes first (head) address from the chain and forwards the resulting packet to the neighbor with that IP address.

If the Router address chain is empty, the router broadcasts the semantic packet until reaching a router with a connection to the service ID or until expiring the radius R. In the former case the router sends the payload of the semantic packet toward the border router that is reachable via the interfaces configured with the ServiceID. All routers within the geographic area execute the last directive carried in the semantic packet (Forward.pkt. end).

The two operational phases (announcement and forwarding) make use of a semantic packet format, which is based on an IPv6 routing header defined based on a new routing type “semantic Routing”, which has the following fields:
Routing type: semantic
Directive index: number of octets from the start of directive list. The initial value is set to 0 and it points to the first directive to be executed. The value is incremented by the number of octets of the total size of a directive after the directive is executed.
Left directives: Remained number of directives. The initial value is set to the total number of directives. The value is decremented by one after one directive is executed. The minimum number is one, and it indicates that the end of the directive list is reached.
Chain Index: used in proactive mode to point to the current element in a routing chain used in some directives.
Directive list: a list of directives. This list may have variable size.
Paddings: set accordingly with IETF RFC8200.

The semantic packet is used to carry different directive lists on different phases of the Protocol:

The actions to be performed for each type of routing directive is described in this section.

Table 1, below, presents a summary of the name and arguments of each directive.

TABLE 1

| Directive Name | Action | Arguments |
|---|---|---|
| Forward.pkt.areaID | Forward packet | Geolocation ID of the |
| | to specific | geographic area of the |
| | geographic area | destination border router. |
| Forward.pkt.servID | Broadcast packet | IP address of the border |
| | towards specific | router with radius R. |
| | Service ID | Radius R used to forward the |
| | | packet to the service ID (IPv6 |
| | | address) indicated in the |
| | | packet header. |
| Discover.path.to.areaID | Collects | Geolocation ID of the |
| | information about | geographic area of the |
| | routers in the | destination border router. |
| | path towards a | |
| | specific | |
| | geographic area | |
| Create.reverse.pkt | Creates a new | Null (creates a new semantic packet |
| | semantic packet | with information collected in the |
| | | header and extended header of a |
| | | received sematic packet) |
| Forward.pkt.chainID | Forwards packet | Router address chain |
| | via a set of know | collected from the received |
| | routers | semantic packet. |
| | | Router address chain locally |
| | | stored for the received |
| | | service name. |
| Stores.chain.servID | Store information | Null (stores the Router address |
| | about a received | chain associated to the service which |
| | chain of routers | ID as indicated in the packet header |
| | | as destination IP) |
| Forward.pkt.end | Ends the | Null |
| | execution of | |
| | directives | |

### BRIEF DESCRIPTION OF THE DRAWINGS

FIG. 1 shows a flowchart of the method;

FIG. 2 shows the semantic route general signaling; and

FIG. 3 shows a format of a semantic packet.

### DETAILED DESCRIPTION OF THE PREFERRED EMBODIMENTS

The illustrations in the figures are schematic and not to scale. If the same reference signs are used in different figures in the following description of the figures, they designate identical or similar elements. However, identical or similar elements can also be designated by different reference symbols.

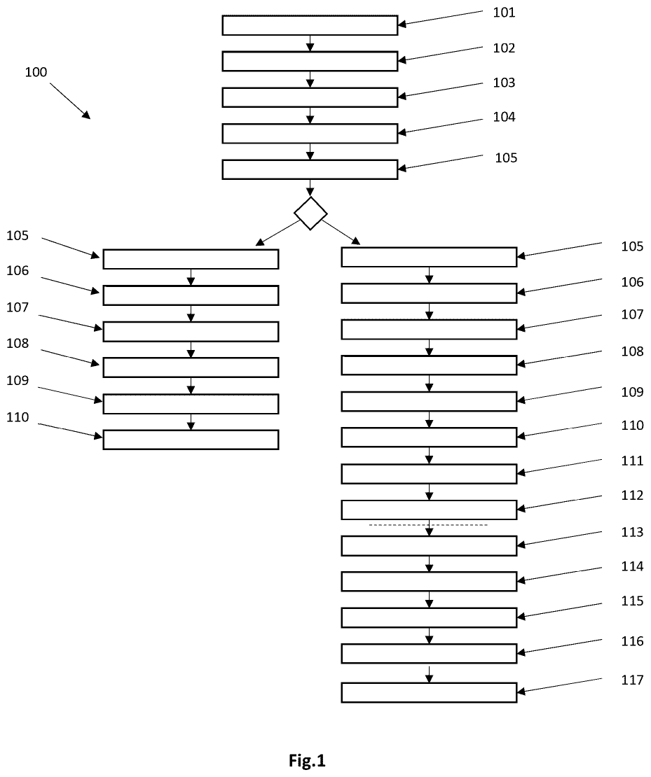

FIG. 1 shows a flowchart of a semantic routing method 100 for time varying networks, wherein the method 100 is configured to provide a congestion-aware source-based routing for satellites, preferably LEO constellations, with a distributed name resolution system, comprising
a multitude of routers,
a multitude of border routers,
a service provider,
wherein the method 100 comprises an announcement phase comprising the following steps:
101 Create a border router order list of the multitude of border routers by incremental order their distance to a current border router;
102 Create, by the current border router, a semantic packet with a list of several directives pairs of the following type:
Forward (Forward.pkt.areaID) the semantic packet to specific geographic area with geolocation ID of a geographic area of a destination border router;
Broadcast (Forward.pkt.servID) the semantic packet towards specific service ID with the IP address of the multitude of a border router with a radius R;
End (Forward.pkt.end) the execution of directives;
103 Execute, by the current border router, the first directive on the list;
104 Receive, by the multitude of routers, the semantic packet and execute the directives starting from the first one, wherein:
if a router is not in the geographic area of the destination border router, further forward the semantic packet to neighbor routers; or
if a router is in the geographic area of the destination border router, the semantic packet is broadcasted within the geographic area until it reaches a router with a connection to the destination border router or expiring the radius R, wherein the router with a connection to the destination border router or expiring the radius R sends the payload of the semantic packet to the current border router and the router with a connection to the destination border router or expiring the radius R executes the following directive in the semantic packet, wherein all the other routers within the geographic area execute the last directive carried in the semantic packet (Forward.pkt.end);
wherein the method 100 further comprises a forwarding phase, wherein information previously exchanged between the multitude of border routers is used to forward data packets, wherein the forwarding phase is configured to be executed in a proactive mode or a reactive mode, wherein:
in the proactive mode, the multitude of border routers trigger themselves a semantic packet with a path discovering message to specific services in order to identify the most suitable path, wherein the information about the identified path is placed in a local routing table and used as tags in future semantic packets allowing a faster forwarding inside the time-varying network, and
in the reactive mode, the multitude of border routers trigger the transmission of a semantic packet to carry a data packet that was received from an interface connecting to an external network, wherein the multitude of border routers create a semantic packet that is forwarded by routers, which do not store any state in the process, wherein the semantic packet comprises a header with the IP address of the border router as source address and the IP address of a destination service, as well as a payload with the received data packet and an extended header that allows the payload to be distributed in a unicast mode,
such that the method 100 is operated based on geographic routing, which is able to adapt to network dynamic, forwarding traffic via a set of satellites as close as possible from the destination, wherein executing the forwarding phase in the reactive mode (left branch) comprises the following steps:
105.1 Receive, by the multitude of border routers, a semantic packet from an external network,
106.1 Use, by the multitude of border routers, a service name carried in the received data packet to check local stored information in order to identify a border router hosting that service,
107.1 Select, from the list of possible hosting border routers, a specific one that is based on a configured forwarding strategy,
108.1 Create, by the multitude of border routers, of a semantic packet with the following routing directives in the extended header:
Forward (Forward.pkt.areaID) packet to specific geographic area with geolocation ID of the geographic area of the destination border router;
Broadcast (Forward.pkt.servID) packet towards specific service ID with the radius R used to forward the packet to the service ID (IPv6 address) indicated in the packet header;
End (Forward.pkt.end) the execution of directives.
109.1 Execute, by the multitude of border routers, the first directive on the list.
110.1 Receive the semantic packet and execute the directives, by the multitude of border routers, starting from the first one, wherein:
if a router is not in the geographic area of the destination border router, forward the semantic packet to the neighbor router that is geographically closer to the destination and which is the least congested one; or
if a router is in the geographic area of the destination border router, the semantic packet is broadcasted within the geographic area until it reaches the router with a connection to the service ID indicated in the packet header or until expiring the radius R, wherein the router sends the payload of the semantic packet to the border router, wherein all the other routers within the geographic area execute the last directive carried in the semantic packet (Forward.pkt.end).

Executing the forwarding phase in the proactive mode (right branch) comprises the following steps:
105.2 Select, by the multitude of border routers, one of locally installed services,
106.2 Create, by the multitude of border routers, a semantic packet with the following routing directives in the extended header:
Collect (Discover.path.to.arealD) information about routers in the path towards a specific geographic area with geolocation ID of the geographic area of the destination border router;
Create (Create.reverse.pkt) a new semantic packet;
End (Forward.pkt.end) execution of directives;
107.2 Execute, by the multitude of border routers, the first directive on the list,
108.2 Receive, by the multitude of border routers, the semantic packet and execute the directives starting from the first one, wherein:
if the router is not in the geographic area of the destination border router, the router:
i. Identifies the neighbor router that is geographically closer to the destination and is the least congested one;
ii. Adds the ID of the selected neighbor node at the head of the router address chain in the packet payload;
iii. Forwards the semantic packet to the selected neighbor router; or
if the router is in the geographic area of the destination border router, the router adds its ID to the head of the Router address chain, and executes the next directive,
109.2 Create, by the destination router, a new semantic packet with the IP address of the current router as source address, the service ID as carried in the previous packet as destination address, the chain-index in the packet head at 1, and the following directives:
Forward (Forward.pkt.chainID) the semantic packet to specific geographic area with router address chain collected from the received semantic packet;
Store (Stores.chain.servID) information about a received chain of routers;
End (Forward.pkt.end) execution of directives.
110.2 Execute, by the destination router, the first directive,
111.2 Execute, by the multitude of border routers, the first directive on the list, forwarding the semantic packet to the router whose IP address is the first as indicated in the directive and increase the chain-index by 1,
112.2 Execute the second directive, by the multitude of routers receiving a semantic packet with a chain-index bigger than the size of the router address chain, and store the router address chain associated to the service which ID as indicated in the packet header as destination IP.

For all services that have a non-empty router address chain, the border router will use the following procedure to forward data packets:
113 Receive, by the border router, a packet from an external network;
114 Use, by the border router, the service name carried in the received data packet to check the local stored information in order to identify the router address chain associated with that service;
115 Create, by the border router, a semantic packet with a header with the IP address of the border router as source address and service ID of the selected service as destination address, as well as with the following routing directives:
Forward (Forward.pkt.chainID) packet via a set of known routers with the Router address chain locally stored for the received service name.
Broadcast (Foward.pkt.servID) the semantic packet towards specific service ID with the radius R used to forward the packet to the service ID (IPv6 address) indicated in the packet header.
End (Forward.pkt.end) the execution of directives;
116 Execute, by the border router, the first directive on the list;
117 Receive, by the multitude of routers, the semantic packet and execute the directives starting from the first one,
wherein, if the router address chain is not empty, the router removes first address from the router address chain and forwards the resulting packet to the neighbor router with that IP address,
wherein, if the router address chain is empty, the router broadcasts the semantic packet until reaching a router with a connection to the service ID or until expiring the radius R, wherein the router sends the payload of the semantic packet toward the border router that is reachable via the interfaces configured with the ServiceID, wherein all routers within the geographic area execute the last directive carried in the semantic packet (Forward.pkt.end).

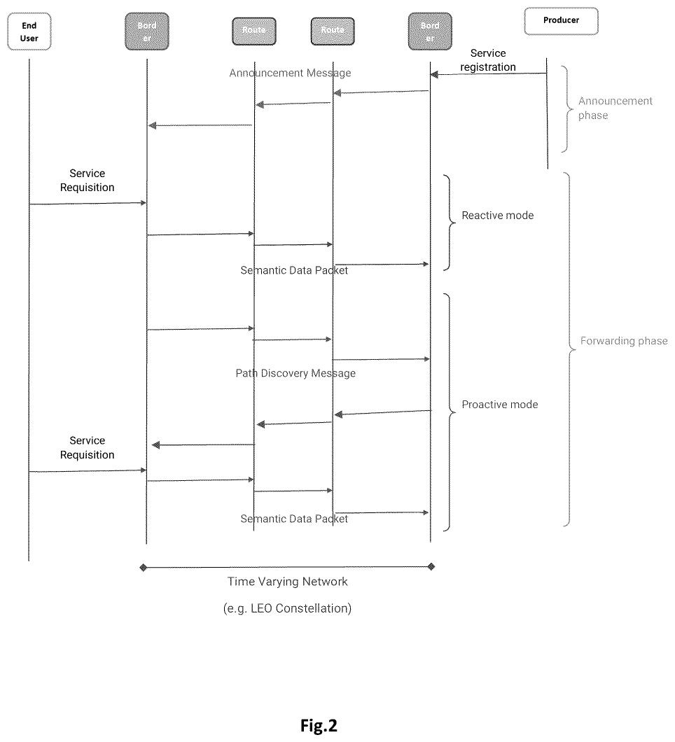

FIG. 2 shows the semantic route general signaling. It illustrates the packet exchange processes occurring between border routers, and passing over a selected set of routers, in order to implement the proposed semantic routing protocol. As can be seen, the proposed semantic routing protocol encompasses an announcement phase and a forwarding phase. In the latest case, the forwarding phase can follow a reactive or proactive behavior, as described above.

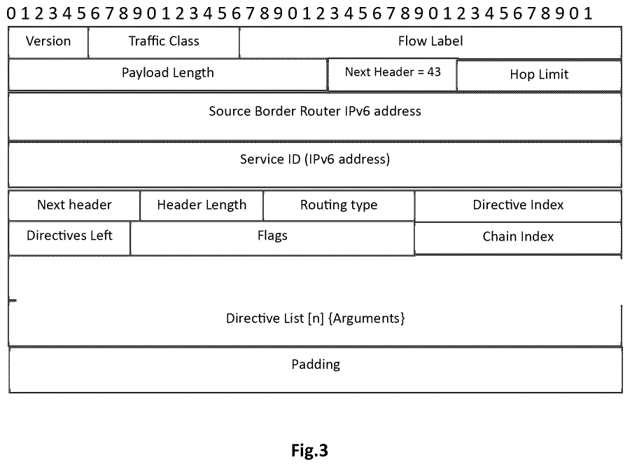

FIG. 3 shows a format of a semantic packet. The two operational phases (announcement and forwarding) make use of a semantic packet format, which is based on an IPv6 routing header defined based on a new routing type “semantic Routing”, which has the following fields:
Routing type: semantic
Directive index: number of octets from the start of directive list. The initial value is set to 0 and it points to the first directive to be executed. The value is incremented by the number of octets of the total size of a directive after the directive is executed.
Left directives: Remained number of directives. The initial value is set to the total number of directives. The value is decremented by one after one directive is executed. The minimum number is one, and it indicates that the end of the directive list is reached.
Chain Index: used in proactive mode to point to the current element in a routing chain used in some directives.
Directive list: a list of directives. This list may have variable size.
Paddings: set accordingly with IETF RFC8200.

In comparison with other approaches that aim to route traffic over a constellation of LEO satellites, this invention has the following benefits:
Operates based on semantics such as geolocation, IP address, service name, information about congestion.
Has an embedded distributed system for resolving service names to semantic addresses.
Uses source based routing allowing satellites to implement a simple routing engine.
Operated based on geographic routing, which is able to adapt to network dynamic, forwarding traffic via a set of satellites as close as possible from the destination.
If aware of congestion, being able to route traffic around congested satellites.
Is able to support multicast traffic by allowing semantic addresses to include multiple destinations.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A semantic routing method for time varying networks, wherein the semantic routing method is configured to provide a congestion-aware source-based routing for satellites with a distributed name resolution system comprising a multitude of routers, a multitude of border routers, and a service provider, wherein the semantic routing method comprises:
an announcement phase comprising the following steps:
create a border router order list of the multitude of border routers by incremental order of a distance to a current border router;
create, by the current border router, a semantic packet with a list of several directives pairs including:
forward the semantic packet to a specific geographic location with geolocation ID of a geographic area of a destination border router;
broadcast the semantic packet towards a specific service ID with an IP address of one of the multitude of border routers with a radius R; and,
end an execution of directives;
execute, by the current border router, a first directive on the border router order list;
receive, by the multitude of routers, the semantic packet and execute the directives starting from the first directive, wherein:
when a router of the multitude of routers is not in the geographic area of the destination border router, further forward the semantic packet to neighbor routers of the multitude of routers within range of the destination border router; or
when one of the multitude of routers is in the geographic area of the destination border router, the semantic packet is broadcasted within the geographic area until the semantic packet reaches a router with a connection to the destination border router or expiring the radius R, wherein the router with the connection to the destination border router or expiring the radius R sends a payload of the semantic packet to the current border router and the router with the connection to the destination border router or expiring the radius R executes a directive in the semantic packet, wherein all the other routers of the multitude of routers within the geographic area execute a last directive carried in the semantic packet;
wherein the method further comprises a forwarding phase, wherein information previously exchanged between the multitude of border routers is used to forward data packets, wherein the forwarding phase is configured to be executed in a proactive mode or a reactive mode, wherein:
in the proactive mode, the multitude of border routers trigger, by themselves, an alternate semantic packet with a path discovering message to specific services in order to identify a most suitable path, wherein the information about the most suitable path is placed in a local routing table and used as tags in future semantic packets allowing a faster forwarding inside a time-varying network, and
in the reactive mode, the multitude of border routers trigger a transmission of the alternate semantic packet to carry a data packet that was received from an interface connecting to an external network, wherein the multitude of border routers create the alternate semantic packet that is forwarded by the multitude of routers, which do not store any state in the transmission of the alternate semantic packet, wherein the alternate semantic packet comprises a header with the IP address of one of the multitude of border routers as a source address and the IP address of a destination service, as well as a payload with a received data packet and an extended header that allows the payload to be distributed in a unicast mode,
such that the method is operated based on geographic routing, which is configured to network dynamic, forwarding traffic via a set of satellites as close as possible from a destination.

2. The semantic routing method according to claim 1, wherein executing the forwarding phase in the reactive mode comprises:
receive, by the multitude of border routers, a semantic packet from the external network.

3. The semantic routing method according to claim 2, further comprising:
utilize, by the multitude of border routers, a service name carried in the received data packet to check local stored information in order to identify a border router of the multitude of border routers hosting the service name.

4. The semantic routing method according to claim 3, further comprising:
select, from a list of possible hosting border routers of the multitude of border routers, a specific hosting border router that is based on a configured forwarding strategy.

5. The semantic routing method according to claim 4, further comprising:
create, by the multitude of border routers, of a semantic packet with routing directives in the extended header, the routing directives comprising:
forward packet to the specific geographic location with geolocation ID of the geographic area of the destination border router;
broadcast packet towards the specific service ID with the radius R used to forward the packet to the service ID indicated in a packet header; and,
end the execution of directives;
execute, by the multitude of border routers, the first directive on the list of possible hosting border routers.

6. The semantic routing method according to claim 5, further comprising:
receive the semantic packet and execute the routing directives, by the multitude of border routers, starting from the first one, wherein:
when the specific hosting border router is not in the geographic area of the destination border router, forward the semantic packet to a neighbor router of the multitude of routers that is geographically closer to the destination router and which is a least a congested router; or
when one of the list of possible hosting border routers is in the geographic area of the destination border router, the semantic packet is broadcasted within the geographic area until the semantic packet reaches a router with a connection to the service ID indicated in the packet header or until expiring the radius R, wherein the router sends the payload of the semantic packet to the border router, wherein all the other routers of the list of possible hosting border routers within the geographic area execute the last directive carried in the semantic packet.

7. The semantic routing method according to claim 1, wherein executing the forwarding phase in the proactive mode comprises:
select, by the multitude of border routers, one of a multitude of locally installed services.

8. The semantic routing method according to claim 7, further comprising:
create, by the multitude of border routers, a semantic packet comprising routing directives in the extended header, the routing directives comprising:
collect information about routers in the path towards the specific geographic area with geolocation ID of the geographic area of the destination border router;
create a new semantic packet;
end execution of directives;
execute, by the multitude of border routers, the first directive on the border router order list.

9. The semantic routing method according to claim 8, further comprising:
receive, by the multitude of border routers, the semantic packet and execute the routing directives starting from the first directive, wherein:
when the router is not in the geographic area of the destination border router, the router:
i. identifies a neighbor router that is geographically closer to the destination border router and is a least a congested router;
ii. adds the ID of a selected neighbor node at a head of a router address chain in the packet payload;
iii. forwards the semantic packet to the identified neighbor router; or
when the router is in the geographic area of the destination border router, the router adds an ID of the router to a head of a router address chain, and executes a next directive.

10. The semantic routing method according to claim 9, further comprising:
create, by the destination router, a new semantic packet with the IP address of the current router as a source address, a service ID as carried in the received semantic packet as a destination address, a chain-index in a packet head starting at an index of 1, and directives comprising:
forward the semantic packet to the specific geographic location with a router address chain collected from the received semantic packet;
store information about a received chain of routers; and
end execution of directives.

11. The semantic routing method according to claim 10, further comprising:
execute, by the destination router, the first directive.

12. The semantic routing method according to claim 11, further comprising:
execute, by the multitude of border routers, the first directive, forwarding the semantic packet to the router having an IP address that is first as indicated in the directive and increase the chain-index by 1.

13. The semantic routing method according to claim 12, further comprising:
execute a second directive of the directives, by the multitude of routers receiving the semantic packet with a size of the chain-index bigger than a size of the router address chain, and store the router address chain associated to a locally installed service which ID as indicated in the packet header as a destination IP.

14. The semantic routing method according to claim 13, wherein for all services that have a non-empty router address chain, a border router of the multitude of border routers uses a procedure to forward data packets comprising:
receive, by the border router, a packet from the external network;
use, by the border router, a service name carried in the received data packet to check the local stored information in order to identify a router address chain associated with said service name;
create, by the border router, a semantic packet with a header with an IP address of the border router as a source address and a service ID of said service as a destination address, and routing directives comprising:
forward packet via a set of known routers with the router address chain locally stored for a received service name;
broadcast the semantic packet towards a specific service ID with the radius R used to forward the packet to the service ID indicated in the packet header; and,
end the execution of directives; and,
execute, by the border router, the first directive on the list;
receive, by the multitude of routers, the semantic packet and execute the directives starting from the first directive,
wherein, when the router address chain is not empty, the border router removes a first address from the router address chain and forwards a resulting packet to a neighbor router with the first address.

15. The semantic routing method according to claim 14, wherein, when the router address chain is empty, a border router broadcasts the semantic packet until reaching a router with a connection to the service ID or until expiring the radius R,
wherein the border router sends the payload of the semantic packet toward the border router reachable via interfaces configured with the service ID, and
wherein all routers within the geographic area execute the last directive carried in the semantic packet.
